(19) United States
(12) Patent Application Publication
(10) Pub. No.: US 2026/0338142 A1
(43) Pub. Date: Oct. 29, 2026

(54) FUEL INJECTOR ARRANGEMENT FOR INSTALLING A FUEL INJECTOR IN AN INTERNAL COMBUSTION ENGINE

(71) Applicant: Robert Bosch GmbH, Stuttgart (DE)

(72) Inventors: Alexander Fuchs, Adnet (AT); Christian Graspeuntner, Hallein (AT); Martin Rainer, Tamsweg (AT); Sven Pasedach, Hallein (AT); Walter Walkner, Anif (AT)

(21) Appl. No.: 19/122,298

(22) PCT Filed: Sep. 13, 2023
(86) PCT No.: PCT/EP2023/075174

§ 371 Date: Apr. 18, 2025

(30) Foreign Application Priority Data
Oct. 19, 2022 (DE) 10 2022 211 054.4

(51) Int. Cl. F02M 21/02; F02M 61/14; F02M 61/16; F02M 61/18

(52) U.S. Cl. CPC F02M 21/0275; F02M 61/14; F02M 61/168; F02M 61/18

(57) ABSTRACT

A fuel injector arrangement for installing a fuel injector (1) in an internal combustion engine, wherein the fuel injector (1) is designed for the metered dispensing of liquid or gaseous fuel, and having a housing (5) comprising an injector body (6) and a jacket tube (10) surrounding the injector body (6), wherein the injector body (6) comprises a fuel inlet (8) and an injection opening (9) for dispensing the fuel. An annular gap (13) is formed between the jacket tube (10) and the injector body (6), forming a fuel flow path. A clamping device (30), via which a clamping force (F) is exerted on the fuel injector (1), pushes the fuel injector (1) against a contact face (4) in the internal combustion engine, wherein the clamping device (30) exerts the clamping force at least indirectly onto the jacket tube (10). The end face (14) of the jacket tube (10) facing the injection opening (9) is supported on a pressure face (16) of the injector body (6).

### BACKGROUND

The invention relates to a fuel injector arrangement for installing a fuel injector in an internal combustion engine, wherein the fuel injector is preferably designed for the metered dispensing of liquid or gaseous fuel into a combustion chamber of an internal combustion engine.

In direct-injection internal combustion engines, the fuel, which may be gaseous or liquid, is directly introduced into a combustion chamber of the engine. The fuel is introduced into the combustion chamber at high pressure at the right time using a fuel injector, which is typically located in the cylinder head of the engine. The fuel-air mixture is then either externally ignited, usually with the aid of a spark plug, or it is ignited solely by the compression of the combustion chamber air (self-ignition) according to the principle of a diesel engine. Because the fuel injector protrudes into the combustion chamber, it is exposed to the pressure in the combustion chamber. Therefore, the arrangement in the cylinder head must meet the following requirements: First, the fuel injector must withstand the pressure created by combustion and the corresponding temperatures in the combustion chamber. Second, the combustion chamber gases must be sealed within the combustion chamber so that they do not escape between the fuel injector and the wall of the bore.

To achieve this, a fuel injector is secured in a bore in the cylinder head using a clamping device, usually a clamping jaw or a fixing screw. Such an arrangement is known, for example, from DE 101 55 678 A1. The clamping jaw is fork-shaped and surrounds the injector. By tightening a clamping screw, the clamping jaw is pushed against the injector, thus pressing it into the receiving bore of the cylinder head against a corresponding sealing face. Because the force required for sealing is relatively high, the clamping force causes an elastic deformation of the force-conducting portions of the injector and leads to an influence on previously established component pairings. For injectors that are used in order to inject liquid fuel into an engine's combustion chamber, this deformation typically does not play a role. The flow cross-sections within the injector body are relatively small here, and the injectors are therefore quite solidly constructed so that the clamping force does not cause any significant deformation.

For injectors used for injection or blow-in of alternative fuels, especially gaseous fuels, significantly larger flow cross-sections in the injector are required, because the energy density of these fuels is considerably lower. Moreover, the fuel pressure is much lower compared to liquid fuel, and a correspondingly large fuel flow rate can only be achieved with a large flow region. Because the design space in the cylinder head is restricted, the injector housing of these fuel injectors is designed with comparatively thin walls. However, the required clamping force remains the same, resulting in a significantly greater deformation of the fuel injector due to the clamping force and thus a change in the established functional dimensions in the injector, for example, the valve lift or the residual air gap. In addition, the variation of the clamping force from one injector to another must also be considered.

### SUMMARY

The fuel injector arrangement according to the invention for installing a fuel injector in an internal combustion engine has the advantage that the fuel injector can be securely installed in the engine, despite relatively large flow cross-sections for the fuel, with a high clamping force and without impairing the operation of the fuel injector due to the clamping. For this purpose, the fuel injector arrangement comprises a fuel injector for the metered dispensing of liquid or gaseous fuel, wherein the fuel injector comprises a housing that includes an injector body and a jacket tube surrounding the injector body. The injector body has a fuel inlet and an injection opening for dispensing the fuel, wherein an annular gap is configured between the jacket tube and the injector body, forming a fuel flow path. There is also a clamping device that exerts a clamping force on the fuel injector and pushes it against a contact face in the engine. The clamping device exerts the clamping force at least indirectly on the jacket tube, wherein the jacket tube supports itself on a pressure face on the injector body with an end face facing the injection opening.

The pressure face can be formed at any height of the injector body, so that the clamping force can be applied via the jacket tube surrounding the injector body relatively close to the combustion chamber, i.e. near the end region of the injector facing the combustion chamber. Thus, the portion of the fuel injector surrounded by the jacket tube is not affected by the clamping device, so that the technical problems caused by the deformation do not occur in this region of the fuel injector. The fuel injector can thus be reliably and securely fastened in the cylinder head bore of the internal combustion engine despite relatively large flow cross-sections, as are needed in particular for gaseous fuel.

In a first advantageous embodiment, the clamping force is exerted by the clamping device on the end of the jacket tube facing away from the pressure face. This is easily accessible, so that the already known jaw or clamping devices can be used.

In a further advantageous embodiment, the injector body comprises a nozzle body, in which the injection opening is formed and which forms the combustion chamber-side end portion of the body, wherein the pressure face is formed on the nozzle body. Thus, the clamping force introduction on the fuel injector is moved far towards the combustion chamber, which minimizes the deformations of the injector body. In particular, the nozzle body, which forms the combustion chamber-side end of the injector body, provides an advantageous location for the pressure face.

In a further advantageous embodiment, the pressure face is formed on the injector body. This can be easily produced using a turning process, for example. Also in an advantageous configuration, the pressure face can be formed on a snap ring that engages into an annular groove on the injector body. Such snap rings have proven effective and can be easily implemented on various injector bodies.

In a further advantageous embodiment, the pressure face is formed on a union nut, which is screwed into an external thread formed on the injector body. This easily creates a pressure face on the injector body. The union nut can be placed at any location on the injector body by providing an external threading.

In a further advantageous configuration, the jacket tube is formed from two partial jacket tubes that are longitudinally adjacent, wherein an intermediate seal is arranged between the two partial jacket tubes. This arrangement has the advantage that the partial jacket tube facing the combustion chamber can be fixedly connected to the injector body, for example by a screw threading. The second partial jacket tube can be fitted from above, i.e. from the side of the injector facing away from the injection opening. This facilitates the mounting and thus the installation of the fuel injector arrangement in an internal combustion engine.

In a further advantageous embodiment, a seal is arranged between the end region of the jacket tube facing away from the pressure face and the injector body. This allows the annular space formed between the jacket tube and the injector body to be reliably sealed, even when applying the clamping force to the jacket tube.

In a further advantageous embodiment, the end face of the jacket tube that faces away from the pressure face is formed in a spherical or conical shape. This can be combined in an advantageous configuration with an additional sleeve, which is arranged between the clamping device and the jacket tube. Because the clamping device pushes on the sleeve and the sleeve then pushes on the jacket tube, the sleeve exerts an inwardly directed force on the end face of the jacket tube, thereby preventing, or at least reducing, a relative movement of the injector in the jacket tube. Advantageously, the end face of the sleeve that cooperates with the end face of the jacket tube is formed in a spherical or conical shape, so that the inwardly directed force on the end face of the jacket tube is increased.

In a further advantageous embodiment, the clamping device is designed as a clamping jaw. The clamping jaw has the advantage that it can be pushed laterally over the injector, for which purpose it is preferably fork-shaped. High clamping forces can be applied without having to redesign the end region of the fuel injector facing away from the combustion chamber, which remains freely accessible for further connections. An inwardly directed clamping surface is advantageously formed on the clamping jaw, which exerts an inwardly directed force on the jacket tube in order to bring the jacket tube into contact with the injector body.

In a further advantageous configuration, the fuel injector is positioned in a receiving bore of the engine, wherein the contact face is formed in the receiving bore. The clamping force pushes the fuel injector against the contact face and seals the receiving bore at this location so that the combustion chamber gas cannot escape between the wall of the receiving bore and the fuel injector.

### BRIEF DESCRIPTION OF THE DRAWINGS

The drawing shows various exemplary embodiments of the internal combustion engine according to the invention. The following are shown:

FIG. 1 a partially sectioned view of a fuel injector having a corresponding clamping device in the cylinder head of an internal combustion engine,

FIG. 2 an enlargement of the section of FIG. 1 designated II,

FIG. 3 shows a further exemplary embodiment in the same view as FIG. 2, as does

FIG. 4 and

FIG. 5, showing further exemplary embodiments,

FIG. 6 shows a further embodiment with an alternatively designed jacket tube,

FIG. 7 the end of the jacket tube facing away from the combustion chamber, in order to illustrate the clamping force,

FIG. 8 the section of FIG. 7 designated VIII in an enlarged view,

FIG. 9 a plan view of the top side of the fuel injector with a clamping jaw, and

FIG. 10 a view of the clamping jaw in a representation rotated in relation to FIG. 9.

### DETAILED DESCRIPTION

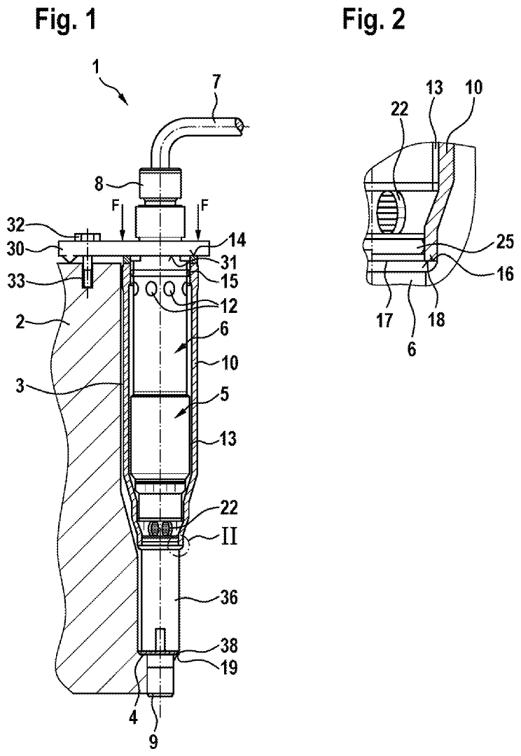

FIG. 1 shows an internal combustion engine according to the invention. The fuel injector 1 is arranged in a receiving bore 3 in a cylinder head 2 of an internal combustion engine, wherein, for the sake of clarity, the cylinder head 2 is only shown on the left side of the fuel injector 1 but also continues on the right side. The fuel injector 1 abuts a sealing face 19 with the interposition of a combustion chamber seal 38 on an annular contact face 4 in the receiving bore 3, so that a seal is formed between the fuel injector 1 and the contact face 4. At the combustion chamber-side end of the fuel injector 1, an injection opening 9 is formed through which the fuel from the fuel injector 1 can be introduced into a combustion chamber of the internal combustion engine. The fuel injector 1 comprises a housing 5 having an injector body 6 and a jacket tube 10, wherein the jacket tube 10 surrounds the injector body 6 over a majority of its length. On the injector body 6, a fuel inlet 8 is formed, which is connected to a fuel line 7 via which gaseous or liquid fuel can be supplied to the fuel injector 1. Fuel introduced via the fuel inlet flows from the fuel inlet 8 through transverse bores 19 into an annular space 13 formed between the jacket tube 10 and the injector body 6, and further towards the injection opening 9 through the annular space 13. The fuel flows from the annular space 13 back into the injector body 6 via second transverse bores 22 and, via fuel channels configured within the injector body 6 and not shown in the drawing, passes into a nozzle body 36, which is part of the injector body 6 and in which the at least one injection opening 9 is formed. A movable valve element, not shown in the drawing, is arranged in the nozzle body 36, which opens the injection opening 9 at the desired time so that the fuel can be dispensed in measured amounts.

With an end face 18, the jacket tube 10 abuts with its end region facing the injection opening 9 against a pressure face 16 of the injector body 6, as shown in FIG. 2 in an enlargement of the section of FIG. 1 designated II. The seal between the jacket tube 10 and the injector body 2 is ensured by a sealing ring 25, which prevents fuel from leaking out. At the opposite end of the jacket tube 10, a seal 15 in the form of a sealing ring is arranged between the injector body and the jacket tube 10, which at this point ensures the sealing between the jacket tube 10 and the injector body 6, so that the annular space 13 is sealed outwardly.

In order to fix the fuel injector 1 in the receiving bore 3 and to ensure a secure sealing on the contact face 4, a clamping force is exerted on the end face 14 of the jacket tube 10 with the aid of a clamping device 30, which in the exemplary embodiment shown here is in the form of a clamping jaw. The latter is fork-shaped and surrounds the injector body 6, wherein the clamping surface 31 formed on the clamping jaw 30 rests against the end face 14 of the jacket tube 10. The clamping jaw 30 is tightened by a clamping screw 32 engaging a screw hole 33 in the cylinder head. A yoke-shaped clamping jaw is also possible, which is clamped on both sides with a clamping screw in the cylinder head. Alternatively, the clamping device can also be configured as a union nut, which is screwed into an internal threading in the receiving bore 3. The clamping force is directed onto the pressure face 16 via the jacket tube 10 and thus close to the combustion chamber-side end of the fuel injector 1. The region within the jacket tube 10 of the injector body 6 is not, or barely, mechanically deformed by the clamping force, so that movable components arranged within this injector body are not affected in terms of their functionality by an elastic deformation of the injector body 6.

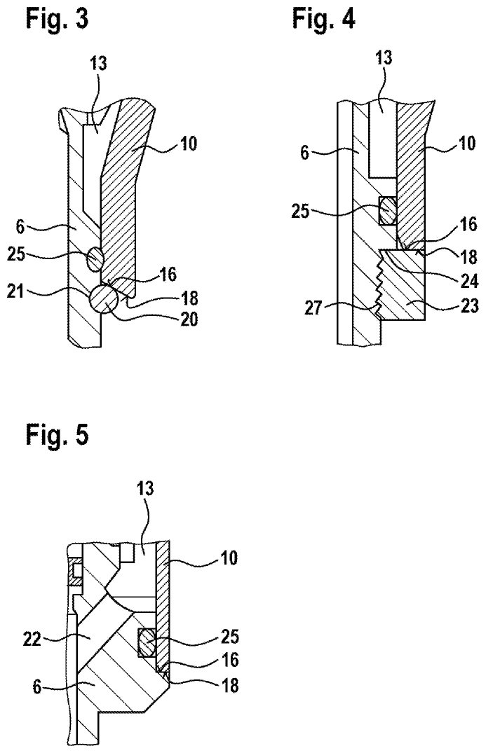

FIG. 3 shows a further alternative configuration of the combustion chamber-side end of the jacket tube 10. The jacket tube 10 here has a conical end face 18 that abuts a clamping ring 20 that forms the pressure face 16. The clamping ring 20 is inserted into an annular groove 21 in the injector body 6 or nozzle body 36. For a secure seal, a sealing ring 25 is additionally placed between the end region of the jacket tube 10 and the injector body 6.

FIG. 4 shows a further exemplary embodiment illustrated in the same manner as FIG. 3. The pressure face 16 is arranged here on a union nut 23, which is screwed into an external threading 27 on the nozzle body 36. The union nut 23 is tightened against and thus fixed against a counterface 24, which is formed on a shoulder of the injector body 6. With its end face 18, the jacket tube 10 abuts the pressure face 16 of the union nut 23, wherein an additional sealing ring 25 is also provided between the jacket tube 10 and the nozzle body 36.

FIG. 5 shows a further exemplary embodiment illustrated in the same manner as FIG. 4. The pressure face 16 is formed on an outwardly projecting shoulder of the nozzle body 36, wherein the jacket tube 10 abuts with its end face 18 against this pressure face 16. Because the shoulder projects radially relatively far outward, the jacket tube 10 in this exemplary embodiment can be configured as a simple cylindrical tube that can be pushed over the injector body 6 from the inlet end of the fuel injector 1. In the exemplary embodiments in which the jacket tube 10 has a larger diameter at the upstream end of the fuel injector 1 than at the opposite end, the jacket tube is pushed over the fuel injector 1 from the side of the injection opening 9, wherein the pressure face 16 must be formed or installed subsequently, such as with the aid of a clamping ring 20 (see FIG. 3) or through a shoulder 17, which is subsequently attached to the injector body 6—for example by a weld joint.

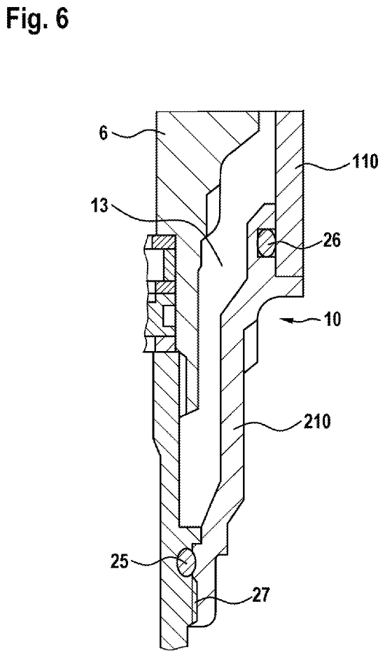

FIG. 6 shows a further exemplary embodiment of the jacket tube 10. The jacket tube 10 consists here of a first partial jacket tube 110 and a second partial jacket tube 210. The second partial jacket tube 210 is screwed into an external thread 27′ on the injector body 6, and the gap between the second partial jacket tube 210 and the injector body 6 is sealed by a sealing ring 25. The first partial jacket tube 110, which is configured here as a straight cylinder, is then pushed on from the end of the injector body 6 facing away from the combustion chamber and sealingly connected to the second partial jacket tube 210. The two partial jacket tubes 110, 210 abut one another, wherein the sealing is carried out by an intermediate seal 26 in the form of a sealing ring. As a result, the first partial jacket tube 110 can be pushed on as a straight circular cylinder from the fuel inlet side, which facilitates the installation within the cylinder head.

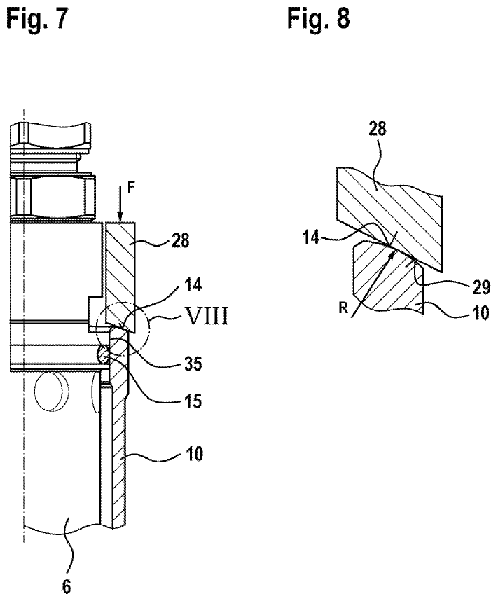

FIG. 7 shows again the end of the jacket tube 10 and the injector body 6 facing away from the combustion chamber. The clamping force F is exerted on the jacket tube 10 here, with the interposition of a sleeve 28. The end face 18 of the jacket tube 10 is configured in a convex or conical shape and has a radius R. The end face 29 of the sleeve 28 is conical, so that the sleeve 28 applies a radially inwardly directed force onto the jacket tube 10. This reduces the gap 35 between the jacket tube 10 and the injector body 6 and improves the fixation at this point between the jacket tube 10 and the injector body 6. The clamping force F on the sleeve 28 can also be applied by a clamping jaw. For clarity, FIG. 8 shows an enlargement of the section of FIG. 7 designated VIII.

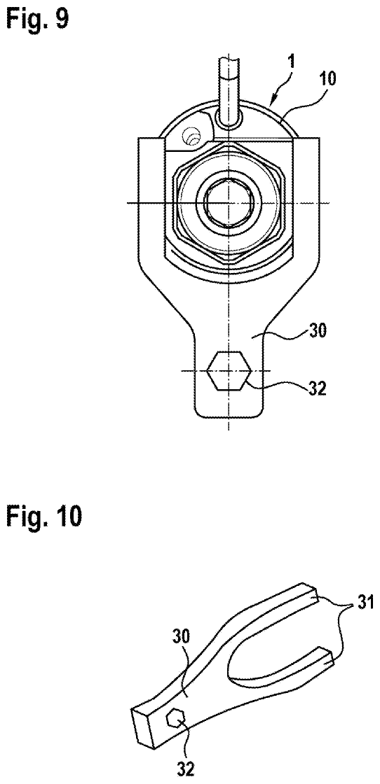

FIG. 9 shows a clamping device 30 in the form of a clamping jaw, as already shown in FIG. 1, wherein a top view of the upper part of the fuel injector 1 (i.e. the part facing away from the combustion chamber) is shown here. The clamping jaw 30 is fork-shaped and surrounds the injector body 6 so that a clamping force can be exerted onto the jacket tube 10 or the sleeve 28, if one is provided. The clamping jaw 30 is tightened via a clamping screw 32, which engages into a corresponding threading in the cylinder head, and thus transfers the clamping force to the fuel injector 1. FIG. 10 shows a further perspective view of the clamping jaw 30. The clamping jaw 30 has a clamping surface 31 which abuts the fuel injector or the jacket tube 10 in the installation position. The clamping surface 31 can be chamfered, as can be the end face 29 of the sleeve 28, so that an inwardly directed force is directly exerted onto the jacket tube 10.

1. A fuel injector arrangement for installing a fuel injector (1) in an internal combustion engine, wherein the fuel injector (1) is configured for the metered dispensing of liquid or gaseous fuel, having a housing (5) comprising an injector body (6) and a jacket tube (10) surrounding the injector body (6), wherein the injector body (6) comprises a fuel inlet (8) and an injection opening (9) for dispensing the fuel, and wherein an annular gap (13) is formed between the jacket tube (10) and the injector body (6), forming a fuel flow path, and having a clamping device (30), via which a clamping force (F) is exerted on the fuel injector (1), pushing the fuel injector (1) against a contact face (4) in the internal combustion engine,
wherein
the clamping device (30) exerts the clamping force at least indirectly onto the jacket tube (10), wherein the end face (18) of the jacket tube (10) facing the injection opening (9) is supported on a pressure face (16) of the injector body (6).

2. The fuel injector arrangement according to claim 1, wherein the clamping device (30) exerts the clamping force (F) onto an end of the jacket tube (10) facing away from the pressure face (16).

3. The fuel injector arrangement according to claim 1, wherein the injector body (6) comprises a nozzle body (36) in which the injection opening (9) is formed and which forms a combustion chamber-side end portion of the injector body (6), wherein the pressure face (16) is formed on the nozzle body (36).

4. The fuel injector arrangement according to claim 1, wherein the pressure face (16) is formed on a shoulder (17) on the injector body (6).

5. The fuel injector arrangement according to claim 1, wherein the pressure face (16) is formed on a snap ring (20) that engages into an annular groove (21) on the injector body (6).

6. The fuel injector arrangement according to claim 1, wherein the pressure face (16) is formed on a union nut (23) screwed into an external thread (27) formed on the injector body (6).

7. The fuel injector arrangement according to claim 1, wherein the jacket tube (10) comprises two partial jacket tubes (110; 210) that are longitudinally adjacent, wherein an intermediate seal (26) is arranged between the two partial jacket tubes (110; 210).

8. The fuel injector arrangement according to claim 1, wherein a seal (15) is arranged between an end region of the jacket tube (10) facing away from the pressure face (16) and the injector body (6).

9. The fuel injector arrangement according to claim 1, wherein an end face (14) of the jacket tube (10) facing away from the pressure face (16) is formed in a convex or conical shape.

10. The fuel injector arrangement according to claim 9, wherein a sleeve (28) surrounding the injector body (6) is arranged between the clamping device (30) and the jacket tube (10) and is pushed by the clamping device (30) against the end face (14) of the jacket tube (10) facing away from the pressure face (16).

11. The fuel injector arrangement according to claim 10, wherein an end face (29) of the sleeve (28) cooperating with the end face (14) of the jacket tube (10) is chamfered such that an inwardly directed force acts on the jacket tube (10).

12. The fuel injector arrangement according to claim 1, wherein the clamping device (30) is a clamping jaw.

13. The fuel injector arrangement according to claim 12, wherein the clamping jaw (30) is fork-shaped and surrounds the injector body (6), wherein an inwardly facing clamping surface (31) is formed on the clamping jaw (30).

14. The fuel injector arrangement according to claim 1, wherein the fuel injector (1) is arranged in a receiving bore (3) of the internal combustion engine, wherein the contact face (4) is formed in the receiving bore (3).
